(19) United States
(12) Patent Application Publication
(10) Pub. No.: US 2012/0153839 A1
(43) Pub. Date: Jun. 21, 2012

(54) AUTOMATIC COLOR CORRECTION FOR A DOME LIGHT DISPLAY DEVICE

(75) Inventors: Joseph D. Farley, Warwick, MA (US); Carl J. Silkey, Hubbardston, MA (US); Richard Beaudry, Westminster, MA (US)

(73) Assignee: SIMPLEXGRINNELL LP, Westminster, MA (US)

(21) Appl. No.: 12/971,581

(22) Filed: Dec. 17, 2010

(51) Int. Cl. H05B 37/02; H05B 41/16

(52) U.S. Cl. 315/152; 315/297; 315/250

(57) ABSTRACT

A device and method that automatically corrects the color of a dome light display device. An dome light display device may include one or more colored light emitting diodes (LEDs) arranged in a row, a photodetector disposed with the one or more LEDs in the row and a measurement circuit is configured to receive an electrical signal from the photodetector and compare the electrical signal to a reference signal associated with an intensity of light for a particular color of light and adjust the intensity of light emitted from the one or more LEDs based on the reference value.

### FIELD OF THE INVENTION

Embodiments of the present disclosure relate to automatic color correction for a dome light display device. More particularly, the present disclosure relates to measuring the output intensity of a light emitting diode (LED) in a row of LEDs in a dome light display device and adjusting power to the LEDs based on the measured output intensity.

### BACKGROUND OF THE INVENTION

Dome light displays may be installed outside of a room, office or other area to indicate the status of a particular situation. For example, certain dome light displays may be installed outside of a hospital room to provide different colors of light to indicate a particular status or situation (e.g. an emergency situation, a patient needing assistance, presence of a caregiver, etc.). However, it is advantageous to install one dome light display that is capable of providing various colors of light associated with different conditions or situations in order to, for example, limit power requirements, provide easy installation, and limit device footprints. Thus, a single dome light display must be capable of emitting various colors of light. This may be accomplished by using light emitting diodes (LEDs) that each emit one of three primary colors, for example, red, green and blue (RGB) LED's (commonly referred to as an RGB LED). By varying the intensity of each of the primary color LEDs, virtually any color light may be produced by the dome light display. RGB LEDs are also used in these displays since they have a more rapid turn-on time and generate less heat per lumen of light relative to conventional lighting products.

However, RGB LED's may vary widely in output intensity. For example, the intensity of the red LED of an RGB LED may be greater or less than the intensity of the green LED at the same drive current, and the intensity of the green LED may be greater or less than the blue LED also at the same drive current, and so on. As a result, fixed color algorithms that intend to provide control of the output color of a dome light display device may produce variable results based on these varying intensities. This is problematic when an output color of the display device signifies or notifies others of an emergency event wherein variations in color could result in incorrect notification to emergency personnel such as those located in hospitals, nursing homes, and other health care facilities. In addition, when dome light displays are installed or inspected, incorrect calibration of the RGB LED's may also produce variable color results thereby compromising emergency notification. Moreover, time and/or temperature may also negatively affect long term color performance of RGB LEDs creating a need to re-calibrate operation of the dome display device. As a result, there is a need to ensure that colors from LEDs used in emergency notification appliances are color calibrated.

### SUMMARY OF THE INVENTION

Exemplary embodiments of the present disclosure are directed to automatic color correction for an emergency dome light display device. In an embodiment, an emergency dome light display device includes one or more colored light emitting diodes (LEDs) arranged in a group where each of the LEDs emits colored light in response to power supplied thereto. A photodetector is disposed with the one or more LEDs and is configured to detect the intensity of light emitted from the LED(s) and generate an electrical signal indicative of this intensity. A measurement circuit is configured to receive the electrical signal from the photodetector and compare the electrical signal to a reference value associated with an intensity of light for a particular color.

In another exemplary embodiment, a method of automatically calibrating light sources within a dome light display includes supplying power to LEDs in a particular row on the dome light display device where the LEDs in the row emit light of a particular color at an intensity which is responsive to the supplied power. The intensity of the emitted light is measured. The measured intensity is compared to a predetermined value associated with an intensity of light for a particular color. The power supplied to the LEDs in the particular row is adjusted based on the comparison of the measured intensity of light with the predetermined value or with respect to the other LED's in the row.

### BRIEF DESCRIPTION OF THE DRAWINGS

FIG. 1 illustrates one embodiment of a system using a plurality of dome light display devices.

FIG. 2 illustrates one embodiment of a dome light display device.

FIG. 3 illustrates a first embodiment of a color calibration circuit.

FIG. 4 illustrates a second embodiment of a color calibration circuit.

FIG. 5 illustrates one embodiment of a logic diagram for calibrating power to an LED in the dome light display device.

### DETAILED DESCRIPTION

Various embodiments are generally directed to a device that automatically adjusts power to an LED to calibrate and correct for variations in output intensity. For example, one or more LEDs in a row or group in a dome device may be activated and the intensity of the light emitted therefrom is measured and power to the LEDs is adjusted based on the measured intensity.

Other embodiments are described and claimed. Various embodiments may comprise one or more elements. An element may comprise any structure arranged to perform certain operations. Each element may be implemented as hardware, software, or any combination thereof, as desired for a given set of design parameters or performance constraints. Although an embodiment may be described with a limited number of elements in a certain topology by way of example, the embodiment may include more or less elements in alternate topologies as desired for a given implementation. It is worthy to note that any reference to “one embodiment” or “an embodiment” means that a particular feature, structure, or characteristic described in connection with the embodiment is included in at least one embodiment. The appearances of the phrase “in one embodiment” in various places in the specification are not necessarily all referring to the same embodiment.

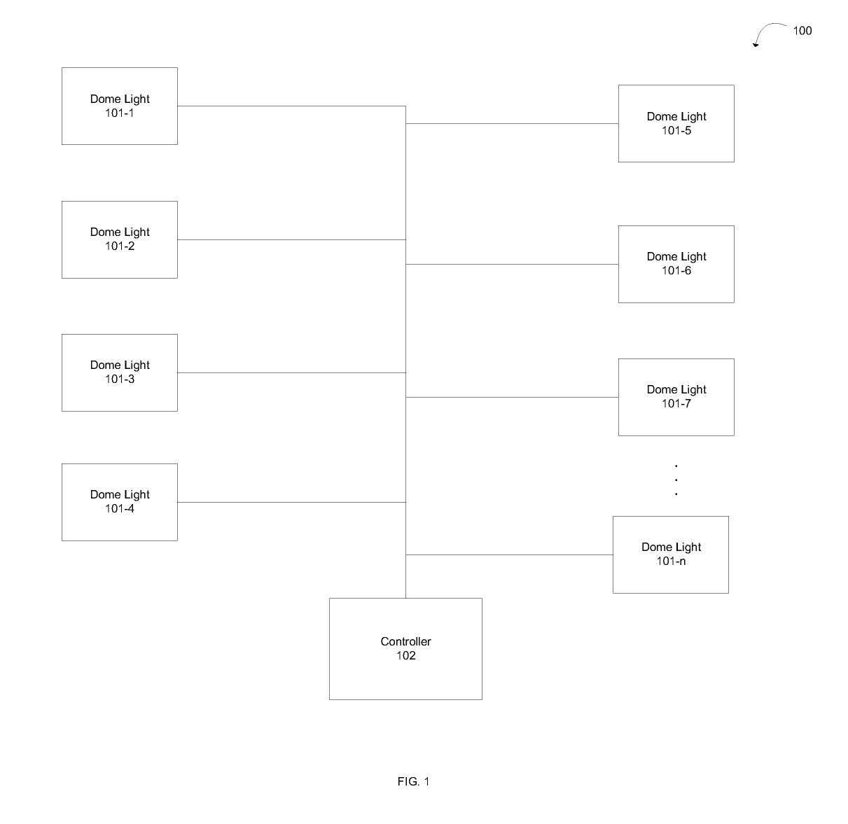

FIG. 1 illustrates a block diagram of a location 100 with a plurality of dome light display devices 101-1-101-n. Location 100 may be, for example, a hospital, a doctor's office, a nursing home or other health care facility, dressing rooms in a department store, an office, etc. Although FIG. 1 may show a limited number of nodes by way of example, it can be appreciated that more or less dome light display devices may be employed for a given location or implementation. For example, if location 100 is a hospital, each dome light display device may be outside a patient's room and configured to emit a particular color light to indicate one of a plurality of conditions as described below. Each dome light display device is connected to a controller 102 that provides a signal to one or more of the dome light displays 101-1-101-n to activate and emit a certain color corresponding to a particular condition. The control of the dome light display device may be local to the dome light display device which, in this example, would be associated with a patient's room rather than through a centrally located controller. Each of the dome light displays 101-1-101-n may be independently powered (e.g. battery) or may be powered from a separate controller.

Each dome light display 101-1 . . . 101-n includes a plurality of RGB LEDs. Generally, an LED is a solid-state device having a PN junction semiconductor diode that emits light when a drive current is applied to the device. An RGB LED includes an R (red) LED, a G (green) LED, and B (blue) LED in a single package. For purposes herein, when reference is made to an R LED, it refers to just the red LED in the single RGB LED package. Similarly, when reference is made to a G LED, it refers to just the green LED in the single RGB LED package and when reference is made to an B LED, it refers to just the blue LED in the single RGB LED package. When each of the R, G and B LEDs is simultaneously driven with the appropriate drive currents, the RGB LED emits white light. Alternatively, when the R, G and B LEDs are separately driven, the RGB LED emits only the respective colors of light or various colors of light desired by a user as the intensity of the colors is separately adjusted by a corresponding drive current of the LEDs. For example, when only red light is desired to be emitted, power is supplied to only the R LED of the RGB LED. When only blue light is desired to be emitted, power is supplied to only the B LED of the RGB LED. Further, as power is supplied to R and B LEDs with the appropriate drive currents, respectively, purple light is emitted. Thus, as current supplied to each of the R, G, and B LEDs is adjusted or present, a color and brightness produced by the RGB LED may be controlled. Accordingly, the dome light display device may mix the various intensities of the R, G and B colored light from each RGB LED to form other colors, such as, but not limited to, pink, orange, yellow, etc.

A dome light display device 101-1 . . . 101-n may display a specific color to indicate a type of service needed. Returning to the example of a hospital, white may indicate a standard patient call, such as a patient requesting water. Red may indicate an emergency, such as, but not limited to, a patient having fallen. Pink may indicate an emergency with an infant. Green may indicate that a nurse is in the room. Yellow may indicate that an aide is in the room. Purple may indicate that a doctor is in the room. Thus, based on the situation or status in a patient's room, a signal may be sent to a dome light display device 101-n to output a particular color which provides an indicator to visually communicate a particular condition or status of what is occurring inside the patient's room to those outside the patient's room.

As the colors indicated by a dome light display device 101-1 . . . 101-n are important to determine how to respond to a patient's needs and/or provide an indication of what is going on inside a patient's room, it is essential that the LEDs in each display produce the desired output color; otherwise, variations in color may compromise the purpose of the visual indicator and consequently the status or situation to those outside the patient's room. In addition, the desired output color also attributes aesthetically at least to the extent that the desired color is accurately displayed (e.g. white is not “off-white”). As discussed above, the intensities for the red, green and blue color components may vary between each LED within a particular RGB LED device as well as between different RGB LED devices. For example, a first RGB LED may have a red LED with a relative intensity of 1, a green LED component with a relative intensity of 1 and a blue component with a relative intensity of 1, each corresponding to a particular drive current. A second RGB diode may have a red component with a relative intensity of 1, a green component with a relative intensity of 1 and a blue component with a relative intensity of 0.5, for the same drive current. As the intensities of the RGB LEDs within the dome light display devices vary, there is a need to calibrate power based on the intensities of the R, G, and B LEDs within the RGB LED to ensure the accuracy of the output color.

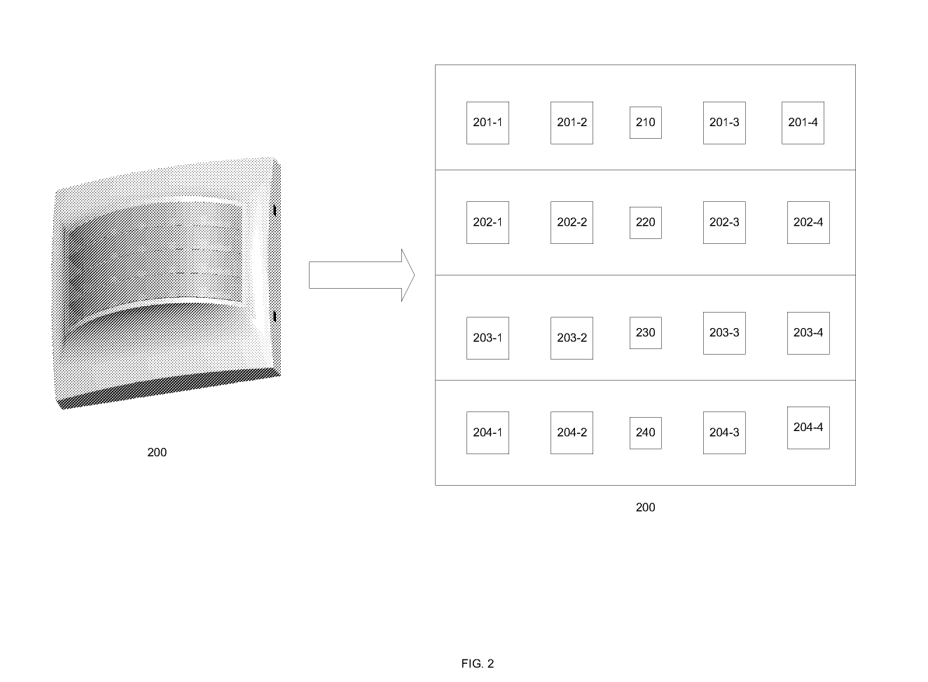

FIG. 2 illustrates an embodiment of a dome light display device. As shown in FIG. 2, a dome light display device 200 has a plurality of rows with one or more LEDs in each row. In this example, the dome light display device includes four segments of color bar rows or groups of LEDs where each row 201, 202, 203 and 204, may be used to display a particular color. The first row may include one or more white LEDs and/or one of the other rows may also include one or more white LEDs. This is because a dome light display may use a white output light frequently and may want to have one or more rows dedicated to white light so that interruption in service is avoided. Another reason to have additional white LEDs is to reduce the cost of the device since RGB LEDs are typically more expensive. For example, in FIG. 2, the first row or group may have four white LEDs 201-1, 201-2, 201-3 and 201-4, the second row may have four RGB LEDs 202-1, 202-2, 202-3, 202-4, the third row may also have four RGB LEDs 203-1, 203-2, 203-3, 203-4 and the fourth row may have four white LEDs 204-1, 204-2, 204-3, 204-4. Alternatively, only one row of LEDs in the dome light display may use one or more white LEDs. For example, the first row or group may have four white LEDs 201-1, 201-2, 201-3 and 201-4, the second row may have four RGB LEDs 202-1, 202-2, 202-3, 202-4, the third row may also have four RGB LEDs 203-1, 203-2, 203-3, 203-4 and the fourth row may also have four RGB LEDs 204-1, 204-2, 204-3, 204-4. Thus, multiple rows may have various configuration of white and RGB LED's. The above embodiments are not limited to the number of LEDs described in a row or group.

Though not necessary, the light emitted by the RGB LEDs in a particular row is preferably the same color throughout the row. For example, it may be desired that the second row light up in pink. Thus, all of the RGB LEDs 202-1, 202-2, 202-3, 202-4 in the second row emit pink light. Each RGB LED within a row (or group) may be activated individually or with a single control; and the RGB LEDs within a row may be turned on and/or off together. In addition, respective drive currents may be applied to each of the RGB LEDs within a row to provide blinking light of a particular color to allow the dome display to provide yet another type of visual indicator or message.

Each row of the dome light display device includes a photodetector 210, 220, 230 and 240 disposed with one or more LEDs in each row. Alternatively, there may be one photodetector 210 per LED in each row. A photodetector 210, 220, 230 and 240 is used to individually measure the output intensity of light output by an LED or group of LEDs and generate an electrical signal indicative of the measured intensity. This electrical signal is used as a basis to modify the amount of power sent to each LED of an RGB LED to produce a desired color as described in more detail below. Each photodetector 210, 220, 230 and 240 may include multiple devices and/or multiple photodetectors where each device or photodetector is sensitive to an intensity of light output by a particular LED(s) associated with a color and measures the output intensity of that LED(s). For example, the photodetector 210, 220, 230 and 240 measures the output intensity of the light produced by all of the RGB LEDs in a row. The photodetector 210, 220, 230 and 240 may measure the output intensity of each LED individually or the photodetector 210, 220, 230 and 240 may measure the output intensity of some or all the LEDs in the row collectively. The photodetector 210, 220, 230 and 240 may be configured to detect the intensity of light emitted from the LEDs in the row and generate an electrical signal proportional to the light emitted from the LEDs. Only a single RGB LED in a row may need to be measured because the RGB LEDs within the row are typically all from the same package from a factory and therefore there is usually little difference in the color components output intensity. One or more RGB LEDs may be measured, individually or collectively, by the photodetector 210, 220, 230 and 240.

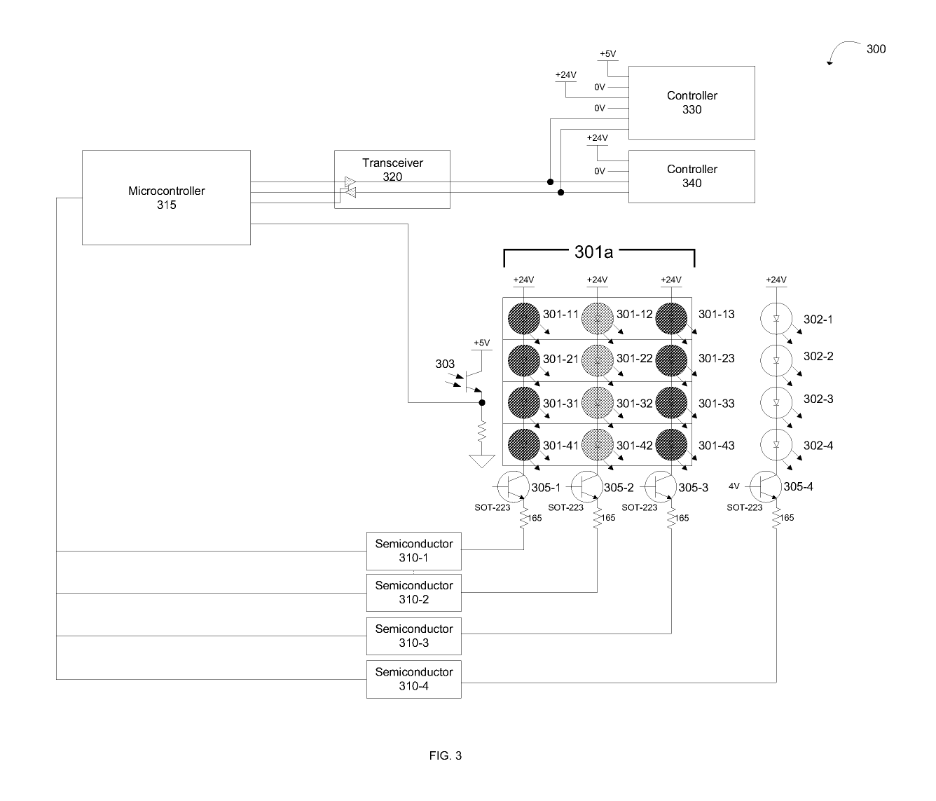

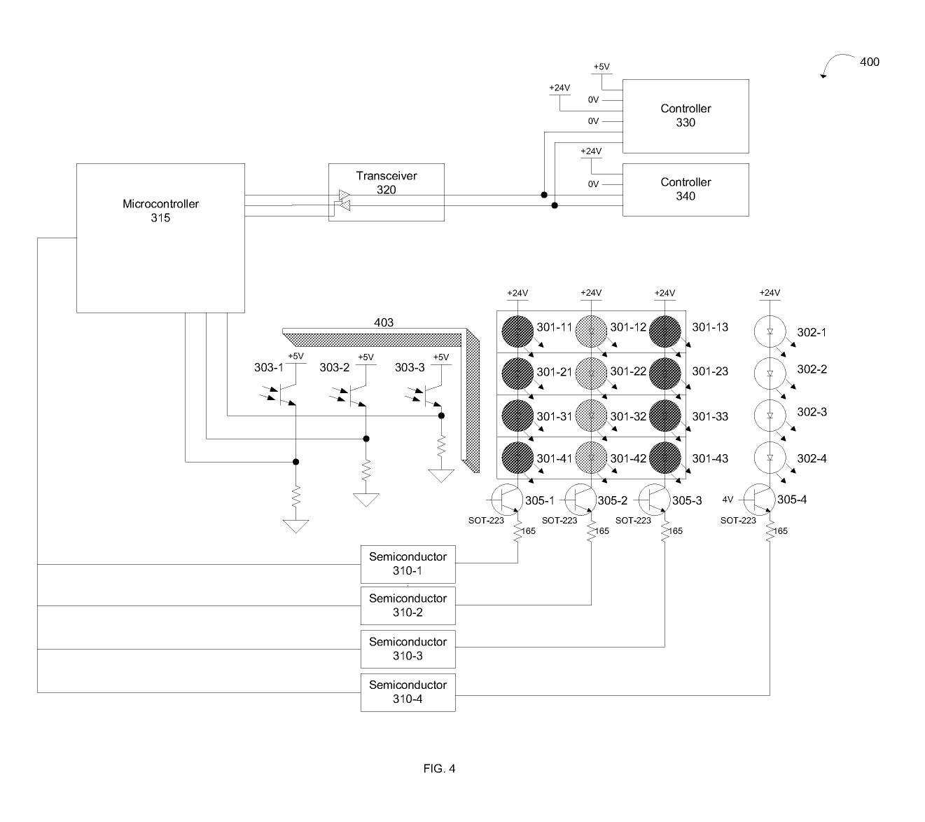

FIGS. 3 and 4 illustrate circuits used to measure the output intensity of light of an LED by the one or more photodetectors 210, 220, 230 and 240 shown in FIG. 2. In particular, FIG. 3 illustrates a first embodiment of a color calibration circuit 300 which includes RGB LEDs 301, white LEDs 302, a phototransistor 303, a transistor or driver 305-1, 305-2, 305-3 and 305-4 associated with each LED color, a driver circuit 310-1, 310-2, 310-3 associated with each color and a driver 310-4 associated with the row of white LEDs 310-4, and a microcontroller 315. As shown in FIG. 3, a first through fourth RGB LEDs define circuit 301a where each RGB LED is defined by the R, G, and B LEDs in each row. In particular, the first RGB LED is defined by R LED 301-11, G LED 301-12 and B LED 301-13. Similarly, the second RGB LED is defined by R LED 301-21, G LED 301-22 and B LED 301-23. The third RGB LED is defined by R LED 301-31, G LED 301-32 and B LED 301-33. Fourth RGB LED is defined by R LED 301-41, G LED 301-42 and B LED 301-43. In this manner, each column (which may also be referred to as a row) includes the same color LED of the RGB LEDs. For example, the first column includes four red LEDs 301-11, 301-21, 301-31 and 301-41, the second column includes four green LEDs 301-12, 301-22, 301-32 and 301-42 and the third column includes four blue LEDs 301-13, 301-23, 301-33 and 301-43. Color calibration circuit 300, which is not duplicated in subsequent rows, also includes four white LEDs 302-1, 302-2, 302-3 and 302-4 as discussed with respect to FIG. 2. The second, third and fourth rows in the dome light display device of FIG. 2 may have circuits identical to the circuit 300 depicted in FIG. 3. One microcontroller 315 may be used with multiple identical circuits 301a.

Each row also includes a phototransistor 303 which is used to detect and measure the light outputted by each color of the RGB LED's in circuit 301. Thus, in this example there would be one (1) phototransistor, one for each four (4) RGB LEDs. The phototransistor will measure the output of the group of four LEDs collectively. The measured light is converted to an electrical signal and supplied to microcontroller 315 which may include a measurement circuit that compares electrical signals representing the detected light from the photodetector and compares it to a reference value representative of a particular color of light. Based on the desired output intensity of the LED's in circuit 301 and consequently the color light emitted by the corresponding dome display device, microcontroller 315 controls drivers 310-1 . . . 301-4 as will be described in more detail below with reference to FIG. 4. Alternatively, the light outputted by each color of the RGB LED's in circuit 301 may be measured by a photodetector and an analog to digital (A/D) converter.

FIG. 4 illustrates a second embodiment of a color calibration circuit. The color calibration circuit may include a circuit 400 with multiple phototransistors 303-1, 303-2 and 303-3. Each phototransistor 303-1, 303-2 and 303-3 is sensitive to a particular color. For example, phototransistor 303-1 may measure a red color output, phototransistor 303-2 may measure a green color output and phototransistor 303-3 may measure a blue color output. The measured light output from the LEDs of that color is converted to an electrical signal which is supplied to microcontroller 315. The phototransistors 303-1, 303-2, and 303-3 may be associated with one or more optical filters and/or beamsplitters 403. The optical filter and/or beam splitter may be mounted on, or integrated with, phototransistors 303-1, 303-2 and 303-3 and configured to filter out colors emitted by one or more LEDs. For example, an optical filter and/or beamsplitter may filter out the green and blue colors for phototransistor 303-1, the red and blue colors for phototransistor 303-2, and the red and green colors for phototransistor 303-3. By having other colors filtered out by the optical filter and/or beamsplitter 403, the phototransistor 303-1, 303-2 and 303-3 may measure only the output of a specific color.

Referring to FIGS. 3 and 4, each color may be associated with a transistor 305-1, 305-2, 305-3 and 305-4 or other switching device, such as, but not limited to, a field-effect transistor used to turn on particular LED's in circuit 301 based on signals received from drivers 310-1 . . . 310-4. The transistors 305-1 . . . 305-4 are depicted as small outline transistors (SOT) which are relatively small, inexpensive surface mount packages widely used in electronic devices. However alternative transistors may be used to turn on LED's in circuit 301. In particular, transistor 305-1 may be associated with the red LEDs 301-11, 301-21, 301-31, and 301-41. Transistor 305-2 may be associated with the green LEDs 301-12, 301-22, 301-32, and 301-42. Transistor 305-3 may be associated with the blue LEDs 301-13, 301-23, 301-33, and 301-43. Transistor 305-4 may be associated with the white LEDs 302-1, 302-2, 302-3, and 302-4. Drivers 310-1 . . . 310-4 provide drive current to respective transistors 305-1 . . . 305-4 to produce the desired LED color. For example, if the dome light display device needs to display brown light, then the red LEDs 301-11, 301-21, 301-31 and 301-41 receives a drive current from at 100% of the transistor capacity while the green LEDs 301-112 301-22, 301-32 and 301-42 receive a drive current set at 50% of the transistor capacity.

Semiconductors 310-1, 310-2, 310-3 and 310-4 may be used to vary the intensity of the output of each LED. The capacity of the transistor 305-1, 305-2, 305-3 and 305-4 may be 100% and the pulse width modulation (PWM) on the drivers 310-1, 310-2, 310-3 and 310-4 may turn a particular colored light component on and off at a certain rate. For example, driver 310-2 may turn all LEDs on and off at a rate of 100 kHz, with the duty cycle of red being 100%, and the duty cycle of blue being 50%.

Microcontroller 315 is configured to receive an electrical signal from each of the phototransistors 303 representing the light intensity from each of the LEDs. Microcontroller 315 compares this electrical signal to a reference signal or value representative of a particular color of light. This reference signal or value may be stored in memory as part of the microcontroller or in a separate memory module that interfaces with microcontroller 315. A reference value or signal representative of an intensity of light which is associated with a particular color of light may indicate an expected signal strength for the corresponding color. For example, if the color is being created using a pulse width modulation duty cycle, then the microcontroller 315 may adjust the pulse width modulation used by the one or more drivers 310-1, 310-2, 310-3 and 310-4. The microcontroller 315 adjusts or corrects the drive current of the one or more transistors 305-1 . . . 305-4 associated with the particular color LED to control the output color thereof. Power to the LEDs may be adjusted the first time a dome light display device is used and/or calibrated after fabrication. The power may also be calibrated or tested periodically such as monthly, semi-annually, annually, and/or other set or random periods of time in order to counteract any change in color output intensity over time.

Transceiver 320 is disposed between controller 315 and controller 330 and/or controller 340 and is configured to provide signals to microcontroller 315 in order to turn on the LED's in circuit 301a to generate the desired color and intensity of light. Controllers 330 may be a remote controller using serial communication to send a control signal to the corresponding dome light display device. The transceiver 320 may be connected to controller 330 which may be a non-centrally-located room terminal to control the operation of the dome light display device. The transceiver 320 may be connected to controller 340 when there is a controller board or room controller used at location 100. Alternatively, input to the microcontroller to turn on the LED's in circuit 301a may be initiated locally (e.g. within a patient's room) by a call button, pull station or other local type switch.

The color corrected power amounts associated with an LED in a row may be used for all LEDs in the particular row. Referring briefly back to FIG. 2, if the first RGB LED 202-1 in the second row is measured and the amount of power is adjusted based on the light measured by photodetector 220, then the same power may be sent to the other RGB LEDs in the second row 202-2, 202-3 and 202-4. In FIGS. 3 and 4, the second row of LEDs may correspond with red light 301-11, green light 301-12 and blue light 301-13 of the RGB LED. In addition, each row of LEDs may be tested individually or collectively and the results are the basis for using the microcontroller 315 to configure the power for the entire row of LEDs.

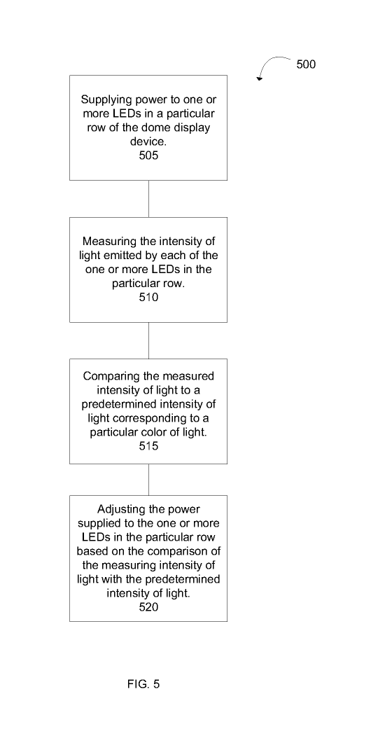

FIG. 5 illustrates a logic diagram for an embodiment for calibrating power to an LED in the dome light display device. Logic flow 500 may be representative of the operations executed by one or more embodiments described herein. As shown in logic flow 500, power may be supplied to one or more LEDs in a particular row on the dome light display device at step 505. The one or more LEDs in the particular row emit an intensity of light in response to the power supplied thereto. One or more of the red, green and blue lights within the LED may be activated automatically. The one or more LEDs may be activated prior to the first use of the dome light display device and the one or more LEDs may be automatically activated after a period of time. After fabrication, one or more of the red, green and blue lights within each LED may be automatically activated. The intensity of light emitted by each of the one or more LEDs in the particular row is measured at step 510. An electrical signal representative of the measured intensity of light is generated and supplied to the microcontroller. A detector circuit, such as, but not limited to, a phototransistor circuit, measures the output intensity of the one or more LED's. One or more driver circuits may be controlled by a pulse-width modulation (PWM) duty cycle to drive the LED's via a transistor associated with a particular group of the LED's. The measured intensity of light output by the LED's is compared to a predetermined intensity of light corresponding to a particular color of light at step 515. The generated electrical signal may be compared with a reference signal representing a particular color of light.

The power supplied to the LEDs in the particular row may be adjusted based on the comparison of the measured intensity of light with the predetermined intensity of light at step 520. The power supplied to the LEDs in the particular row may be adjusted by activating one or more transistors via drivers connected to each of the LEDs and updating the pulse-width modulation (PWM) duty cycle associated with each of the LEDs. In addition, the pulse width modulation duty cycle associated with the LEDs in the row may be adjusted. Alternatively, this adjustment of power supplied to the LEDs may be accomplished by varying the current to each LED.

Numerous specific details have been set forth herein to provide a thorough understanding of the embodiments so as to be understood by those skilled in the art, however, that the embodiments may be practiced without these specific details. In other instances, well-known operations, components and circuits have not been described in detail so as not to obscure the embodiments. It can be appreciated that the specific structural and functional details disclosed herein may be representative and do not necessarily limit the scope of the embodiments.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

Some embodiments may be implemented, for example, using a machine-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within the computing system's registers and/or memories into other data similarly represented as physical quantities within the computing system's memories, registers or other such information storage, transmission or display devices. The embodiments are not limited in this context.

While the present invention has been disclosed with reference to certain embodiments, numerous modifications, alterations and changes to the described embodiments are possible without departing from the sphere and scope of the present disclosure, as defined in the appended claims. Accordingly, it is intended that the present invention not be limited to the described embodiments, but that it has the full scope defined by the language of the following claims, and equivalents thereof.

1. A dome light display device comprising:
one or more colored light emitting diodes (LEDs) arranged in a group, each of said LEDs emitting colored light in response to power supplied thereto;
a photodetector disposed with said one or more LEDs, said photodetector configured to detect intensity of light emitted from the LED(s) and generate an electrical signal indicative of the intensity; and
a measurement circuit configured to receive said electrical signal from said photodetector, and compare said electrical signal to a reference value associated with an intensity of light for a particular color.

2. The dome light display device of claim 1 wherein the comparator circuit is part of a microcontroller, the microcontroller configured to adjust the intensity of light emitted from the one or more LEDs based on the comparison of said electrical signal to the reference value.

3. The dome light display device of claim 2 wherein the microcontroller adjusts the intensity of light by modifying a drive current supplied to the one or more LEDs in the row.

4. The dome light display device of claim 2 wherein the microcontroller adjusts the intensity of light by modifying a pulse width modulation duty cycle supplied to the one or more LEDs in the row.

5. The dome light display device of claim 1 wherein a plurality of said one or more LEDs is a red, green, blue (RGB) LED.

6. The dome light display device of claim 1, further comprising a plurality of groups wherein one group comprises one or more white LEDs.

7. The dome light display device of claim 1 wherein each of the one or more LEDs arranged in a group display a same color.

8. A circuit comprising:
one or more light emitting diodes (LEDs) in a group; and
a photodetector in the group with the one or more LEDs, wherein the photodetector is configured to measure an intensity of light output by each of the one or more LEDs in the group.

9. The circuit of claim 8, further comprising a driver circuit electrically coupled to the group of LEDs and configured to provide power to said LEDs.

10. The circuit of claim 8 wherein the photodetector is configured to generate an electrical signal indicative of the measured intensity of light.

11. The circuit of claim 9 further comprising a measurement circuit configured to receive said electrical signal from said photodetector and compare said electrical signal to a reference value associated with an intensity of light for a particular color.

12. The circuit of claim 11, wherein the measurement circuit is part of a microcontroller, the microcontroller configured to adjust the intensity of light emitted from the one or more LEDs based on the comparison of said electrical signal to the reference value.

13. The circuit of claim 8 wherein the circuit is part of a dome light display device.

14. A method of automatically calibrating light sources within a dome light display comprising:
supplying power to one or more LEDs in a particular row on the dome light display device, said one or more LEDs emitting light of a particular color at an intensity which is responsive to said supplied power;
measuring the intensity of the emitted light;
comparing the measured intensity to a predetermined value associated with an intensity of light for a particular color; and
adjusting the power supplied to the one or more LEDs in the particular row based on the comparison of the measured intensity of light with the predetermined value.

15. The method of claim 13 wherein adjusting the power supplied to the LEDs further comprises activating a drive circuit to modify the power supplied to the LEDs.

16. The method of claim 13 wherein adjusting the power supplied to the one or more LEDs further comprises adjusting a pulse width modulation duty cycle associated with the one or more LEDs.

17. The method of claim 13 wherein measuring the intensity of light emitted by each of the one or more LEDs in the particular row further comprises generating an electrical signal representative of the measured intensity of light.

18. The method of claim 13 wherein at least one of said LEDs comprises a red LED, a green LED and a blue LED (RGB LED), the step of supplying power to one or more LEDs in a particular row further comprises automatically activating one or more of the red, green and blue LEDs within the RGB LED.
